(19) United States
(12) Patent Application Publication
(10) Pub. No.: US 2007/0132689 A1
(43) Pub. Date: Jun. 14, 2007

(54) Liquid crystal display panel capable of easily adjusting grayscale voltage

(75) Inventors: Li-Ya Li, Shenzhen (CN); Yi-Yin Chen, Miao-Li (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/636,225

(22) Filed: Dec. 8, 2006

(30) Foreign Application Priority Data
Dec. 8, 2005 (CN) 200510102280.8

(51) Int. Cl. G09G 3/36

(52) U.S. Cl. 345/89

(57) ABSTRACT

A liquid crystal display panel includes a first substrate, a second substrate opposite to the first substrate, and a liquid crystal layer sandwiched between the first substrate and the second substrate. The first substrate and the second substrate cooperatively form a multiplicity of pixels. The first substrate also includes a pixel pad electrically connected to one of the pixels. According to this configuration, a grayscale voltage of the liquid crystal display panel can be conveniently adjusted.

### BACKGROUND OF THE INVENTION

1. Field of the Invention

The invention relates to a liquid crystal display panel, and particularly to a liquid crystal display panel configured for adjusting a grayscale voltage thereof easily.

2. General Background

The image on a screen of a liquid crystal display (LCD) panel of an LCD is composed of many picture elements known as pixels. A pixel can be considered to be a single point in an array of points that make up the image. In a color LCD, each pixel includes three dots (or sub-pixels): a red (R) sub-pixel, a green (G) sub-pixel, and a blue (B) sub-pixel. In a so-called backlit LCD, a light source is provided behind the array of pixels. A level of brightness of the light source can be adjusted. Further, the amount of backlight that penetrates through each sub-pixel can be modulated by electrically driving liquid crystal located at the sub-pixel. Thus each sub-pixel can display a desired individual level of brightness, so that the color of the sub-pixel has a desired saturation. “Grayscale” indicates different levels of brightness from darkness (black) to brightness (white). When there are many grayscale levels, the desired sub-pixel image can be displayed very precisely. For example, an 8-bit LCD panel of an LCD can show 256 brightness levels, which is also known as 256 grayscales. Different brightness levels of the RGB sub-pixels cooperatively compose the colored image displayed on the screen of the LCD panel. When a dynamic image is displayed on the screen, the variation of color in each pixel displayed by the LCD panel comes from the variation of grayscale voltage applied to each sub-pixel of the pixel.

The gamma value of an LCD panel describes the relationship of different grayscales and their corresponding brightnesses. Typically, the gamma curve is represented as a two dimensional plot using Cartesian axes. The X-axis includes 0˜255 grayscale values. The Y-axis includes a value of a ratio of brightness produced by each grayscale value to a maximum brightness (white screen). The gamma curve is usually non-linear, and the so-called gamma value of the LCD panel is usually set at 2.2.

Referring to FIG. 2, this is an isometric view of a conventional method for adjusting the grayscale voltage of an LCD panel by using an optical instrument. Firstly, the optical instrument 100 (such as the “BM5A” model manufactured by Topcon Optical Co., Ltd.) is used to measure the gamma value of the LCD panel 200. Then the voltage of each corresponding grayscale is adjusted according to the gamma value. In a typical example, the required gamma value of the LCD panel 200 is 2.2. The optical instrument 100 measures the actual gamma value of the LCD panel 200 from the grayscales of each R, G, B sub-pixel of a selected exemplary pixel of a screen 300 of the LCD panel 200. The optical instrument 100 then selects 256 grayscales which meet the required gamma value of 2.2 from 1024 grayscales of a look up table displayed on the screen 300. Then the optical instrument 100 can adjust the gamma value of the LCD panel 200 to the desired value of 2.2.

Also referring to FIG. 3, this shows two graphs and two corresponding schematic diagrams of grayscales in relation to the above-described method. The left-side graph shows transparence varying according to grayscale prior to adjustment of the gamma value of the LCD panel 200. Diagram (I) below the graph represents a corresponding view of the unadjusted grayscales. The right-side graph shows transparence varying according to grayscale after adjustment of the gamma value of the LCD panel 200. Diagram (II) below the graph represents a corresponding view of the adjusted grayscales. It should be noted that even though the graphs and Diagrams (I) and (II) are in relation to 256 grayscales, the graphs and Diagrams (I) and (II) are simplified representations only. Curve A in the left-side graph depicts the non-adjusted gamma value, and curve B in both graphs depicts the gamma value (2.2) after adjustment. Therefore Diagram (I) illustrates the variation in grayscale in relation to the non-adjusted gamma value of curve A, and diagram (II) illustrates the variation in grayscale in relation to the adjusted gamma value of curve B. As seen, in Diagram (I) the brightnesses of certain consecutive grayscales is identical. That is, the brightnesses of these consecutive grayscales do not vary in proportion to their grayscale values. In Diagram (II), after the gamma value is adjusted, the brightnesses of these consecutive grayscales varies in proportion to their grayscale values.

The above-described method for adjusting grayscale voltage requires the use of the optical instrument 100. However, the optical instrument 100 is expensive. Furthermore, the optical instrument 100 and associated equipment occupy extra space in addition to the space needed for the LCD panel 200. Moreover, using the optical instrument 100 to perform the method is rather complicated and time-consuming.

### SUMMARY

A liquid crystal display panel includes a first substrate, a second substrate, and a liquid crystal layer sandwiched between those substrates. The second substrate is set opposite to the first substrate and cooperating with the first substrate to define a plurality of pixels arranged in a matrix for displaying of images. The first substrate has at least a pixel pad electrically connecting to a predetermined pixel so as to adjust gamma value of the liquid crystal display panel by adjusting the voltage applied to one of the predetermined pixel. Additionally, each pixel includes three sub-pixels configured to provide the colors red, green, and blue respectively, and the pixel pad includes three sub-pixel pads so as to electrically connect to the three sub-pixels respectively. In addition, the first substrate includes thin film transistors, and further includes a driving circuit configured to provide a voltage, set adjacent to the pixel pad. When a voltage is applied to one of the pixels, the pixel. pad carries a corresponding voltage, and a gamma value of the liquid crystal display panel can be adjusted by detecting the corresponding voltage and adjusting the voltage applied to one of the pixels accordingly.

### BRIEF DESCRIPTION OF THE DRAWINGS

FIG. 1 is a schematic, top plan view of a liquid crystal display panel according to an exemplary embodiment of the present invention.

FIG. 2 is an isometric view of a conventional method for adjusting the grayscale voltage of an LCD panel by using an optical instrument.

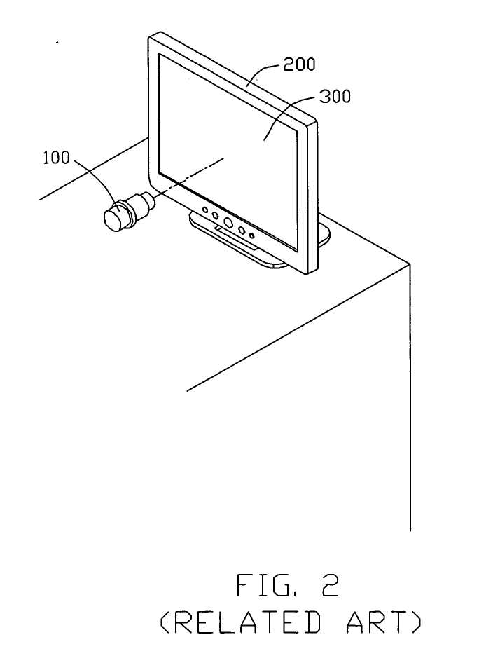

FIG. 3 shows two graphs and two corresponding schematic views of grayscales in relation to the method of FIG. 2.

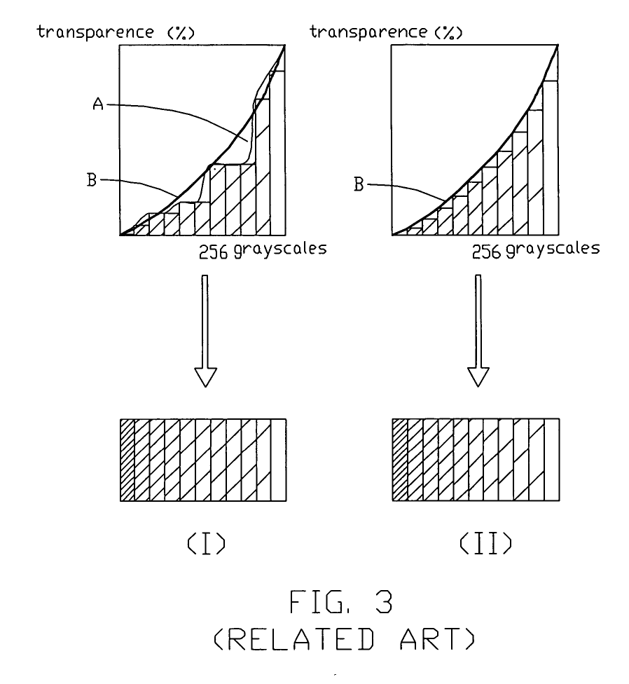

### DETAILED DESCRIPTION OF PREFERRED EMBODIMENTS

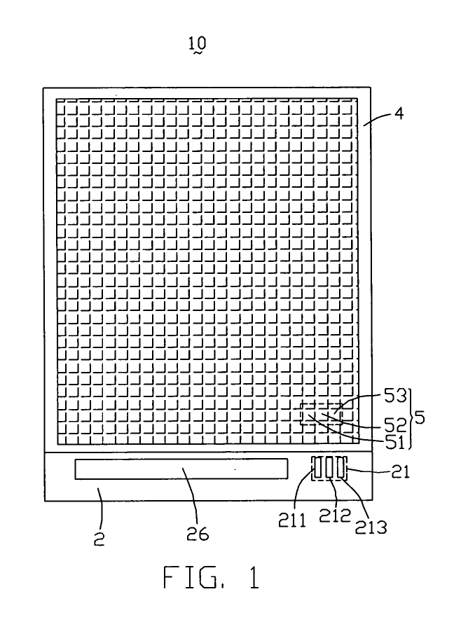

Referring to FIG. 1, this is a schematic, top plan view of a liquid crystal display (LCD) panel according to an exemplary embodiment of the present invention. The LCD panel 10 includes a first substrate 2, a second substrate 4, and a liquid crystal (LC) layer (not shown) sandwiched between the first substrate 2 and the second substrate 4. The first substrate 2 and second substrate 4 are set directly opposite each other, so as to cooperatively form a multiplicity of pixels 5 arranged in a matrix. The pixels 5 are used to cooperatively provide an image for display by the LCD panel 10. Each pixel 5 typically includes at least three sub-pixels 51, 52, 53. In the illustrated embodiment, each pixel 5 includes three sub-pixels 51, 52, 53, which provide the colors red (R), green (G), and blue (B) respectively. The first substrate 2 typically includes thin film transistors (TFTs) (not visible). The first substrate 2 also includes one or more driver ICs 26 (e.g. driving circuits) and a pixel pad 21 arranged on a peripheral side portion thereof. In the illustrated embodiment, the pixel pad 21 is adjacent to a single driver IC 26, and includes sub-pixel pads 211, 212, and 213. The sub-pixel pads 211, 212, and 213 are electrically connected respectively to the sub-pixels 51, 52, and 53 of a predetermined exemplary one of the pixels 5.

In the preferred embodiment, an electrical device such as an oscilloscope can be used to detect voltage variations of the sub-pixel pads 211, 212, and 213 which are electrically connected to the sub-pixels 51, 52, and 53 respectively. Therefore, the grayscale voltage variations of the sub-pixels 51, 52, and 53 can be monitored easily. That is, the corresponding grayscale voltages of the sub-pixels 51, 52, and 53 can be obtained, and an actual gamma value of the LCD panel 10 can be determined. If the required gamma value of the LCD panel 10 is different from the actual gamma value, the actual gamma value can be changed by adjusting the driving voltage of the pixels 5 through the driver IC 26. Thus the adjusted grayscale voltages of the sub-pixels 51, 52, and 53 can be detected through the voltages of the sub-pixel pads 211, 212, and 213. In this way, the actual gamma value of the LCD panel 10 can be adjusted to the required gamma value.

It should be noted that the electrical device (e.g., oscilloscope) is adopted to adjust the grayscale voltages of the LCD panel 10. In particular, the voltages of the sub-pixel pads 211, 212, and 213 of the predetermined exemplary pixel 5 are detected so as to verify the grayscale voltages of all the sub-pixels 51, 52, and 53 of the LCD panel 10. Unlike in the above-described conventional art which uses the optical instrument 100 to measure the grayscale voltages of an LCD panel 200, the grayscale voltages of the sub-pixels 51, 52, and 53 of the exemplary pixel 5 of the LCD panel 10 are in effect measured directly by the oscilloscope. In particular, the grayscale voltages of the R, G, B sub-pixels 51, 52; 53 can be directly and precisely detected through the oscilloscope, and directly and precisely adjusted through the oscilloscope and the driver IC 26.

In alternative embodiments, the sub-pixel pads 211, 212, and 213 can be electrically connected to the sub-pixels 51, 52, 53 of any other pixel 5 on the LCD panel 10. The pixel pad 21 can be formed to be large (as far as is permitted by the layout of the LCD panel 10) in order to facilitate easy testing. The pixel pad 21 can be located at any other suitable place on the second substrate 4 in relation to the driver IC 26.

As would be understood by a person skilled in the art, the foregoing exemplary and preferred embodiments are intended to be illustrative and not restrictive. The above description is intended to cover various modifications and similar arrangements included within the spirit and scope of the appended claims, the scope of which should be accorded the broadest interpretation so as to encompass all such modifications and similar structures.

We claim:

1. A liquid crystal display panel, comprising:
a first substrate;
a second substrate opposite to said first substrate and cooperating with said first substrate to define a plurality of pixels, wherein the pixels are arranged in a matrix for displaying of images; and
a liquid crystal layer sandwiched between said first substrate and said second substrate;
wherein said first substrate comprises a pixel pad, and said pixel pad electrically connects to a predetermined one of the pixels.

2. The liquid crystal display panel in claim 1, wherein each of the pixels comprises three sub-pixels configured to provide the colors red, green, and blue respectively, and said pixel pad comprises three sub-pixel pads electrically connected respectively to the three sub-pixels of said predetermined one of the pixels.

3. The liquid crystal display panel in claim 1, wherein said first substrate comprises a plurality of thin film transistors and a driving circuit, and said driving circuit is adjacent to said pixel pad.

4. A liquid crystal display panel, comprising:
a first substrate;
a second substrate opposite to said first substrate;
a plurality of pixels cooperatively defined by said first substrate and said second substrate, the pixels arranged in a matrix; and
a liquid crystal layer sandwiched between said first substrate and said second substrate;
wherein said first substrate comprises a pixel pad, and said pixel pad is electrically connected to a predetermined one of the pixels; and
when a voltage is applied to said one of the pixels, said pixel pad carries a corresponding voltage, and a gamma value of said liquid crystal display panel can be adjusted by detecting said corresponding voltage and adjusting the voltage applied to said one of the pixels accordingly.

5. The liquid crystal display panel in claim 4, wherein each of the pixels comprises three sub-pixels configured to provide the colors red, green, and blue respectively, and said pixel pad comprises three sub-pixel pads electrically connected respectively to the three sub-pixels of said predetermined one of the pixels.

6. The liquid crystal display panel in claim 4, wherein said first substrate comprises a plurality of thin film transistors and a driving circuit, and said driving circuit is adjacent to said pixel pad.

7. The liquid crystal display panel in claim 6, wherein said driving circuit is configured to provide a voltage to the pixels, and the voltage provided to the pixels is adjustable.

8. A method of measuring grayscale voltages of an LCD panel without using and optical instrument, comprising steps of:
providing a first substrate;
providing a second substrate opposite to said first substrate;
providing a plurality of pixels cooperatively defined by said first substrate and said second substrate, the pixels arranged in a matrix; and
providing a liquid crystal layer sandwiched between said first substrate and said second substrate;
wherein said first substrate comprises a pixel pad, and said pixel pad is electrically connected to a predetermined one of the pixels;
applying a voltage is to said one of the pixels so tat said one of the pixels carries a corresponding voltage; detecting said corresponding voltage and adjusting the voltage applied to said one of the pixels accordingly; and adjusting a gamma value of said liquid crystal display panel.
